(19) United States
(12) Patent Application Publication
(10) Pub. No.: US 2017/0262477 A1
(43) Pub. Date: Sep. 14, 2017

(54) Computerized Content Management System

(71) Applicant: Albert Carroll, North Grafton, MA (US)

(72) Inventor: Albert Carroll, North Grafton, MA (US)

(21) Appl. No.: 15/064,648

(22) Filed: Mar. 9, 2016

(51) Int. Cl. G06F 17/30; G06F 3/0481

(52) U.S. Cl. CPC G06F 17/30268; G06F 3/0481; G06F 17/3056; G06F 17/30867; G06F 17/30554; G06F 17/3028

(57) ABSTRACT

A computerized content management system is provided. The content management system is configured to gather and organize all of a user's content which may be on a local storage medium and also on remote, networked systems. The content management system may provide posting features to allow a user to publicly display content, including an ability to schedule a content display at a future date or event.

### BACKGROUND OF THE INVENTION

Field of the Invention

The present invention relates generally to computerized content management systems. In particular, the present invention provides a solution for centralized storage of photographs that can provide visual organization based on time, with the ability to publicly share or post a photograph from an earlier date at a future date.

Description of Related Art

As various forms of social media and online data storage systems proliferate, users have a tendency to join more than one of them. These systems encourage users to upload their content such as photographs to their particular interface. For example, a single user may upload various content to systems such as Dropbox®, iCloud®, Shutterfly®, Path®, Facebook®, and Instagram®. Furthering the problem, many users store content on local hardware such as physical/digital photographs, video tape, external hard drives and other disc media, smart phones, laptops, desktops, and the like. For most users, it becomes very difficult to keep all of this content in a single location, and it is also very difficult to organize, search, and keep track of this content.

Therefore, what is needed is a content management system that can communicate with other data storage systems to accumulate all of a user's content. The system may further be able to organize the content in time-line format, and may allow for public posting or display of content from a past date on a future date.

### SUMMARY OF THE INVENTION

The subject matter of this application may involve, in some cases, interrelated products, alternative solutions to a particular problem, and/or a plurality of different uses of a single system or article.

In one aspect, the present invention is a computerized content management system configured to provide access to all of a user's content in a single location. The system is further designed to provide intuitive and ready access to all content in a branching format, allowing a user to move through large amounts of content quickly and easily. Further still, an advanced and sophisticated searching module is provided to allow users to quickly identify photographs based on various searching fields. A social networking interface allows users to optionally share and display some or all of their content. This social networking interface allows users to schedule future posting so that they can schedule posts to publicly display content on future dates or events.

In another aspect, a computerized content management system is provided. The system has a user interface module allowing a user to provide an input using a computerized input, and providing to the user outputs on a display of a computer. The system further has a content database, which stores a quantity of content belonging to the user. The content database is accessible to the user through the user interface module of the system. The content management system is configured to gather content of the user from outside online sources when given a login information to the outside online sources. The system is configured to automatically download this content to the content database. Further, the system is configured to display the quantity of content in a branching format through the user interface. This branching format is arranged such that the quantity of content is organized in a date-wise manner having a unit of time represented on a branch. Along this branch, content from this time period is displayed. As noted above, the social networking interface of the system provides access to at least a portion of the quantity of content to other users. The other users are capable of accessing at least a portion of the quantity of content belonging to the user through their user interfaces of their computers. This social networking interface allows users to schedule future posting. The future posting causes these posts and corresponding date and time instructions to be stored in memory until the appropriate time. At the scheduled time or event, the system automatically posts (publicly displays) the selected content.

### BRIEF DESCRIPTION OF THE DRAWINGS

FIG. 1 provides a schematic view of an embodiment of operation of the computerized content management system.

FIG. 2 provides a view of an embodiment of a user interface of the content management system. FIG. 3 provides a flow chart regarding operation of a future posting function of the content management system.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

The present invention is a computerized operational system that solves a computer-specific, internet-centric problem of management and organization of photographs and other media that are presented to computer users when viewing an internet website, application, and the like. Because digital images are stored and viewed on and by computers, the present invention and claimed solution is similarly necessarily rooted in computer technology. The invention solves this computer problem in varying ways using ordered steps, and the combination of these steps confines any alleged abstract ideas that may be contained in the system and the processes it carries out to a particular useful application—that being organization, display, and management of computerized media.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems), and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Generally, the present invention concerns a computerized content management system. The system solves the computer based problem of decentralized content storage, and solves this problem by providing a centralized content management system that can access, and is accessible by, various other systems to provide a centralized location for access, organization, and display of a large quantity of content such as photographs. Further, the system solves the computerized problem of access and display of large quantity of content such as photos by providing centralized content management system with an intuitive access interface and structure.

In one embodiment, the content management system may be primarily used for photographs, with video capability as well. The system may allow for storage and upload of content, as well as in-system organizing, and may be capable of public display and access to the content. The system may be configured to organize content within albums, which may contain photographs, videos, and comment files having comments and information regarding the files within the album. Importantly, the content management system is capable of providing scheduled posting, which may include a user selecting a content or contents, selecting a future date to post (which may be a date, or an event such as a birthday or wedding), and then selecting to whom the posting will be made, whether it be to a particular user, group, or public. This future posting may be particularly advantageous for those who are terminally ill (to allow them to schedule posts post-mortem); soldiers going into deployment or combat; and for storing videos, photographs and other content until a particular event (such as a wedding day, birthday, and the like). Further, in another embodiment, a user may schedule daily, weekly or other recurring posts.

In some embodiments, other social networking systems such as Facebook®, Instagram®, Twitter®, and the like may be capable of accessing content stored on the content database of the content management system. This may allow a user to store all content in one location, while allowing other various outside network systems to access this content.

Also importantly, the computerized content management system may be configured to automatically sort and organize content, such as by date created, date posted, content type, event type, hidden/public, favorited by user, favorited by others (in a social media context) and other content. The system provides a self-organizing and searchable environment. In some embodiments, the computerized content management system may automatically extract data from any photographs uploaded to the system to aid in organization. Searching functions may be performed using a searching module on a number of different features of the content, including searching metadata (EXIF and the like) of content, such as date, location, album, favorite status, name, time taken, and any other tagged or taggable indicator of the content and metadata content.

Digital photographs, and other content contemplated herein for management by the system may contain metadata as part of its data structure. This metadata is data stored within the data container of the content which contains information about the content in which it is stored. For photographs, this may be EXIF data, for example, but is of course not limited to such. The system contemplated herein may be configured to search and analyze metadata of the content stored by the content management system. Further, the system may be configured to automatically organize the content according to common metadata features, including date, time, location, camera type, camera settings, and so on.

In some embodiments, the computerized content management system may automatically access various social media and data storage interfaces using the user's login and password information. The system may then download the content of the various systems to conglomerate all content on the content management system.

The content management system of the present invention may further include a social media aspect. This social media interface aspect may allow different users of the system to view and otherwise access some or all content of other users. However, the user may have the ability to keep some or all of the content private for use as a storage and management system. The social media aspect is also utilized in the automated scheduled posting embodiments discussed herein.

An important feature of the content management system is the automated time-line organization which organizes the content by date. Preferably, this feature is presented to the user in a branching structure such that certain time groups (such as a year) are grouped together on different branches.

The branches being displayed as album files radially extending away from a central trunk. These album files will be shown simulating a branch with curvature. This provides an efficient visual user interface to the user. Further, large contents of data can be easily navigated through using this date-based branching structure. The branching structure may be presented as a tree, having a centralized trunk and the branching time periods extending from the trunk.

In such a tree-based visual user interface, albums (which may be manually or automatically organized and generated) may be organized to simulate a branch patter, with the oldest content on the bottom of the branch/tree. Albums from each year are aligned in a straight, jagged, or curving line resembling a branch. The more content that is stored in the content management system, the more branches there will be. In further embodiments, “bark” on the tree can show the year that it represents. When clicked, it may expose albums from that year as a branch. Further, multiple “trees” may be present, organized by date, amount of content, and the like. In one view, a user may fully zoom out to see a full “tree line” which will identify in a condensed fashion, all of the user's content.

In additional embodiments, the computerized content management system may automatically identify photographs taken on a same date or within a date range and may automatically group them in an album (which may be pre-made by a user or automatically created by the system). Also, if the computerized system is able to identify location of the photographs, it may group them according to location. This may be particularly advantageous for automatically grouping, for example, vacation photographs.

The user interface of the computerized content management system may allow a user to favorite their own photos (which will allow the photos to be searched and organized based on this favoriting). Further, in some embodiments, a user may allow other system users to access some or all photos and content through the social networking interface. Of these accessible photos and content, the users may also favorite certain content. This favoriting may also allow the content to be searched and organized- by grouping them with user-favorited content, or grouping them in a separate, non-user favorited classification. In a particular embodiment, the content management system may generate a collection of most favorited items. These most favorited items may be automatically generated into a slideshow. The user may also add a music track from a local or streamed music file to the slideshow.

A user may have the ability to group and organize other followers or “friends” through the social networking interface. These followers may be organized into certain groups such as family; friends; public; professional, and so on. Based on these groupings, a user may control what follower sees what content. For example, the family grouping may be able to view certain content—such as a family vacation, while the public may not.

In one embodiment, the content management system may allow for multiple users to access a single account. For example, a family may have a single account. Or, a user may have a primary user account, and a backup/secondary user in the event that the user wishes for the other to have control, is inaccessible, dies, or the like.

The content management system may further be configured to automatically generate a greeting card based on uploaded or stored content. The system may provide a prompt to a user to encourage greeting card production. The user may then select one or more items of content (typically photographs), and text. The system may then send a request for printing and send the generated greeting card by mail to either the user or the intended recipient. In a particular embodiment, a user may select the greeting card option. The system may then automatically enable a camera of a user's mobile telephone, coupled with a user guide to walk the user through the greeting card preparation process. These steps may include taking a photograph for the front outside cover, taking a second photograph for the inside of the card, and the like. The card may then be stored in a picture format (e.g. JPEG) but has an icon that symbolizes that it is a greeting card. This card may then be placed in an album and/or shared through the social networking aspect.

The user interface of the present invention may be any interface that may allow for the content organization and conglomeration. In one embodiment, an operations interface may be provided within the user interface. The operations interface may include a number of clickable or otherwise actuatable links or buttons that are displayed on the computerized display. These may include, among others, a new album link; an upload content link—allowing users to directly upload content (including a drag and drop option) or to provide log in information for the system to access and download content from another computerized storage system; a contacts link—which may allow a user to view contacts within the social networking aspect of the system; a recent activity link; a settings link (which may be labeled as “My Tree” according to the tree-inspired embodiments); a favorites link; and a search option, among other things. The new album link may activate a computerized command in the content organization system to organize certain content (which is either selected by the user or automatically transferred by the system as instructed by rules set up by the user).

The new album link may allow a user, through the computerized user interface and interacting with the computerized content management system, to set up the album—this set up may include naming and selecting what content is to be stored within the album. Choosing the content to be organized within the album may include manual selection by the user in one embodiment. In another embodiment, the user may select certain rules which may allow the computerized content management system to automatically scan through the content within the system and accessible to the system, including but not limited to metadata, to identify content relating to these set up rules. For example, an album may be created for all photos taken at a particular location within a certain date range. The computerized system may then analyze each photograph's data, and identify all that fit the criteria for storage in the album. Similarly, a late night photos album could be created for all photographs taken between midnight and 5 am, for example. The computerized system may then analyze all available photographs that were taken (or created) between these times, and may store them or otherwise make them accessible to this album.

The search option of the user interface of the computerized content management system may have advanced search features which may allow a user to find content based on a number of different factors of data and metadata of content. These factors may include, but are not limited to any data carried by each photograph, including location, date and time created, camera taking the photograph, aperture data, and any other data stored by the photograph file. Further, other data relating to the content may be searchable as well, including notes taken for the content, favorited (by user, number, by others) status, views by user, or by others), content shared by others, links to the content, comments, hidden content, and the like. Accordingly, complex searches by the system are possible for a highly specific search system.

In a particular embodiment, the computerized content management system user interface may prompt a user to post according to certain themes. For example, throwback Thursday may identify an item of content and suggest posting of it.

This may be pre-set as a future date post. In another example, the user may be prompted to select daily posts for an upcoming week.

In the social networking aspect of the present invention, a user interface may allow various functions and unique utilizations of the system. Initially, during set up of a user account within the system, the user may input their personal information such as name, email address, password, phone number, birthday, gender, secondary account holder (see above) information, and the like. Once the account is set up, the user can see an automatically updated feed that shows, among other things, contact requests, status updates, what contacts are favoriting what posts, what contacts are sharing, and the like.

A user's contacts list of the user interface can be organized in varying ways, all of which are within the scope of the present invention. In one embodiment, the user's contact list may be organized in a tree shape, having branching visual connections.

In a particular embodiment, the user's personal user interface can show both past posts, as well as scheduled future posts. These may be separate, or may be in a single timeline.

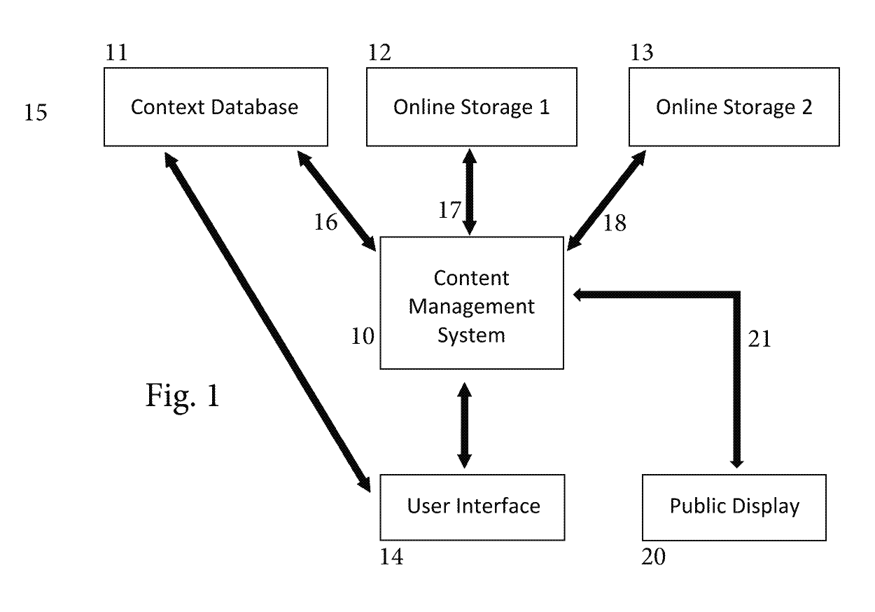

Turning now to FIG. 1, a schematic view of communications between the various modules of the computerized content management system are provided. The content management system 10 is positioned at the center of the figure. This system controls and manages data flow and operation of the various modules of the present invention. A user interface 14 communicates back and forth via data path 19 with the content management system 10. The user interface 14, as discussed above, provides a user of the computerized system with an interactive visual display allowing the user to control aspects of the system. Communication between the user interface 14 and content management system 10 provides the user with updated commands based on interaction. The user interface 14 may also communicate directly with content database 11 via data path 15. The user interface 14 may communicate with the database in situations such as uploading content directly, accessing content from the database 11, and the like. In other embodiments, the communication may be between the user interface 14 and content management system 10, and then to the content database 11 via paths 10 and 16.

The content management system 10 may be configured to access a number of online storage accounts to retrieve content of the user stored in various places online. For example, a user may have photographs stored on Facebook® and also Dropbox®. These systems are represented by online storages 12 and 13. The content management system 10 may be given the access information (user name and password) and may then gather any stored content on each system 12, 13 of the user's, and may save it to content database via data paths 17, 18, and 16.

A user, via user interface 14, may instruct the content management system 10 to publicly, or semi-publicly display content to other users of the system via public display module 20. The content management system 10 may flag certain content stored in the content database 11 as for display to some or all users (see discussion above). The content in this database 11 is then accessible to other users via data path 21.

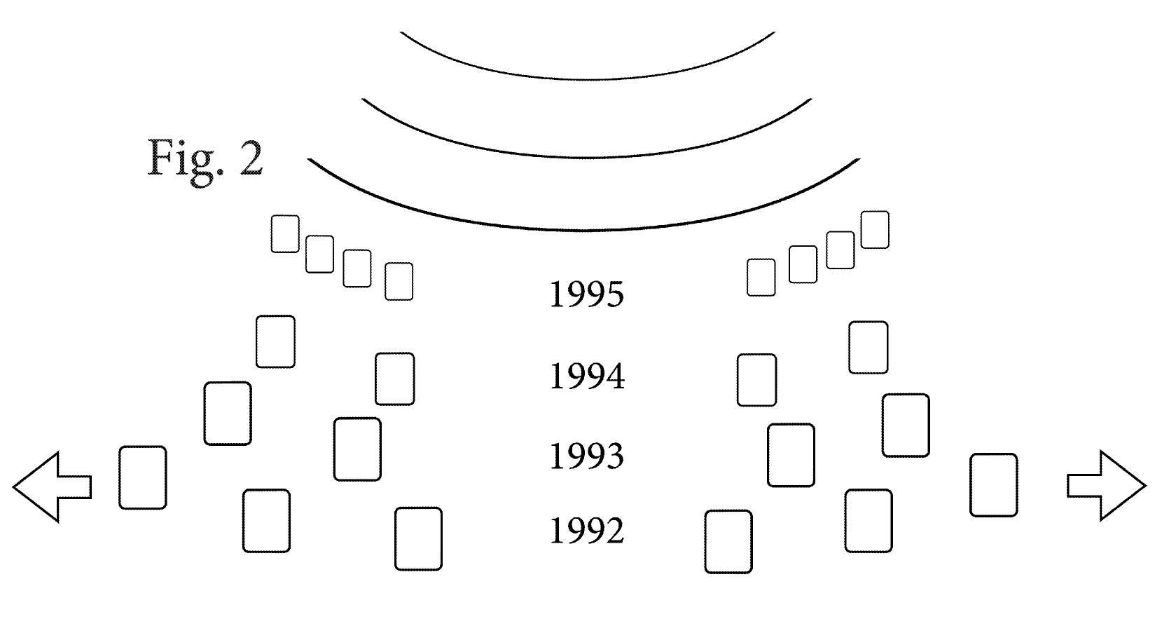

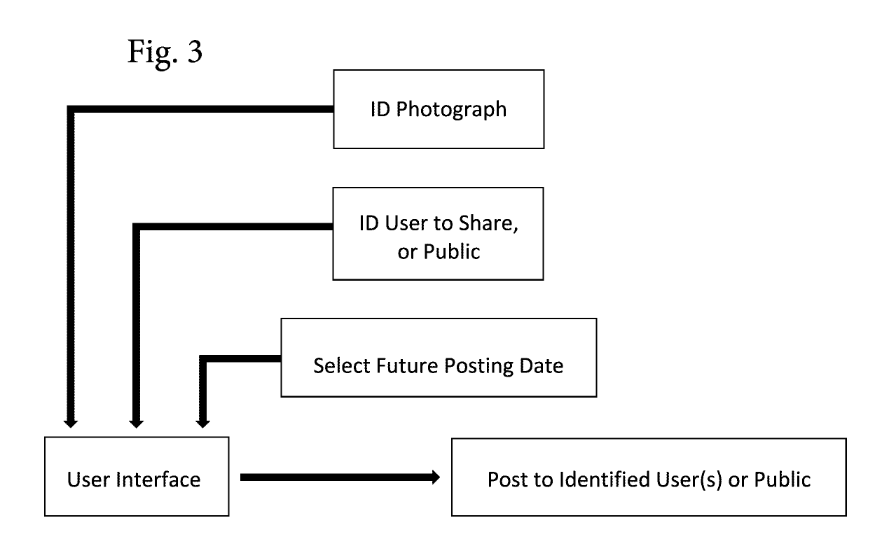

FIG. 2 shows an embodiment of a visual display of a user's content sorted by date. It can be seen that the content of each year is organized on branching extensions. In this view, a first branch line (which is being directly viewed by the user) shows photographs from the year 1992, though of course any year may work. Rectangular boxes to the left and right of the year marker extend along the branches. These rectangular boxes represent albums. A user may click, touch, or otherwise actuate one of these boxes to view either the photos/content within the album, or multiple sub-albums. A user may then scroll up (or down) to move the branches to other years. In further embodiments, a year selection may provide a subset of branching albums from certain months or other time period within the particular year. Arrows on the sides of the branches may indicate that there are additional albums available. In some embodiment, a small preview of what is contained in the album may be displayed within a boundary defined by the album. This preview may be greyed or lightened in some embodiments. Examples of small previews may include a thumbnail photograph, thumbnail video, or text from a note. Further, in one embodiment, when a user scrolls over the album, touches, or lightly touches the album, the preview may become larger and/or display.

FIG. 3 provides a flow chart of the system's operation for future posting. As noted above, a user may schedule one or more future posts that allow the user to publicly display content at a later date. In this embodiment, the user initially identifies the photograph. Next, the user identifies who the content will be available to, whether that be the user, user group, or the public. Lastly, the user selects the future posting date or event (such as a birthday of a user, wedding day, and the like). As shown in the figure, all of these steps is controlled by the user interface. The user interface then communicates with the content management system, which in turn is configured to post the content to the identified user(s) at the scheduled time.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A computerized content management system comprising:
a user interface module allowing a user to provide an input using a computerized input device, and providing a user interface output on a display of a computer;
a content database, the content database storing a quantity of content of the user, accessible to the user through the user interface module;
wherein the content management system is configured to gather a second quantity of content from an outside computerized system when given a login information to the outside system, the content management system configured to automatically download the second quantity of content to the content database;
the content management system being configured to display the quantity of content on the display in a branching format through the user interface, such that the quantity of content is organized in a date-wise manner having a unit of time represented on a branch and content from the unit of time displayed along the branch;
a social networking interface of the system providing access of at least a portion of the quantity of content to a second user, the second user capable of accessing the at least a portion of the quantity of content through a second user interface of a second computer;
wherein the social networking interface is configured to display an item of content at a scheduled date in the future, the system configured to receive an input identifying the selected item of content for future display, and one of a future date and an input identifying a future event for future display; and
wherein upon receipt of the inputs, the content management system stores the inputs in a memory until the one of the identified date and event arrives, and on this occasion, the content management system presents the selected content through the social networking interface.

2. The computerized content management system of claim 1 wherein the quantity of content comprises a plurality of digital photographs, each of the plurality of digital photographs comprising image data and metadata.

3. The computerized content management system of claim 1 wherein the quantity of content comprises digital photographs and digital video.

4. The computerized content management system of claim 2 wherein the computerized content management system is configured to automatically search the metadata of each of the plurality of digital photographs to extract data about each of the plurality of digital photographs, the system further configured to organize the plurality of digital photographs in a plurality of albums based on the metadata extracted.

5. The computerized content management system of claim 4 wherein the system is configured to automatically create an album based on a metadata common to a plurality of digital photographs of the quantity of content, and configured to store the plurality of digital photographs in the automatically created album on the content database.

6. The computerized content management system of claim 5 wherein the metadata common to the plurality of digital photographs is a location that the photograph was taken.

7. The computerized content management system of claim 5 wherein the metadata common to the plurality of digital photographs is a date that the photograph was taken.

8. The computerized content management system of claim 2 further comprising a searching module, the searching module capable of searching the metadata of the plurality of digital photographs.

9. The computerized content management system of claim 1 wherein the social networking interface is configured to provide access to one portion of the quantity of content to a first group of users, and configured to provide access to a second different portion of the quantity of content to a second group of users.

10. The computerized content management system of claim 1 wherein a second user can identify one of the quantity of content as a favorite through the social media interface.

11. The computerized content management system of claim 10 wherein the system is configured to automatically organize content that has been favorited through the social media interface into an album.

12. The computerized content management system of claim 11 wherein the system is configured to automatically display the content that has been favorited as a slideshow, the user capable of providing a music file, the system configured to automatically combine the slideshow and music file to generate a movie file.

13. The computerized content management system of claim 1 wherein the user interface is configured to allow a user to upload a content to the content database.

14. The computerized content management system of claim 1 wherein the user interface is configured to prompt a user to schedule a future post based on a given theme.

15. The computerized content management system of claim 1 wherein the branching format comprises a year-wise organization, with a plurality of digital albums storing a plurality of digital photograph content created in a particular year in each album, such that the albums extend along the branches of the branching format.

16. The computerized content management system of claim 15 wherein each album is automatically generated based on an automatically recognized metadata category identified by the computerized system, the plurality of photographs containing a common metadata content.

17. The computerized content management system of claim 16 wherein the common metadata content is a date created.

18. The computerized content management system of claim 1 wherein the common metadata is a camera type.

19. The computerized content management system of claim 1 wherein the common metadata is a photograph location.

20. The computerized content management system of claim 1 wherein the system displays the selected content for future posting directly to a public display of the second user's social networking interface.
